(19) United States
(12) Patent Application Publication
(10) Pub. No.: US 2016/0078058 A1
(43) Pub. Date: Mar. 17, 2016

(54) FILE SYSTEM AND METHODS FOR COMPARING MULTIPLE INSTANCES

(71) Applicant: Ching-Kay Chow, San Jose, CA (US)

(72) Inventor: Ching-Kay Chow, San Jose, CA (US)

(21) Appl. No.: 14/851,663

(22) Filed: Sep. 11, 2015

Related U.S. Application Data
(60) Provisional application No. 62/049,266, filed on Sep. 11, 2014.

(51) Int. Cl. G06F 17/30; G06K 9/62

(52) U.S. Cl. CPC G06F 17/30259; G06K 9/6202; G06F 17/30345; G06F 17/30994; G06F 17/30106

(57) ABSTRACT

A system provides via a software application, a file sub-system that organizes images of an event for evaluation of an object or event as the object or event changes over time. A base image may be established and other images of the object or event may be co-related to the base image so that a user may select the base image for display along with the other images showing time lapsed changes to the object or event.

### CROSS-REFERENCE TO RELATED APPLICATIONS

This application claims benefit under 35 U.S.C. §119(e) of U.S. Provisional Application having Ser. No. 62049266 filed Sep. 11, 2014, which is hereby incorporated by reference herein in its entirety.

### BACKGROUND

The embodiments herein relate generally to systems and methods for comparing multiple instances.

It has been a common difficult practice for people to compare multiple instances of an event or a changing item. Commonly an object may be recorded at different times and each recording may be saved into an electronic file system. There is very little available to help the user organize electronic files so that objects within the files have a comparable relationship.

A user needs to be very careful when moving the different instances of an object recorded electronically into a directory over time. Typically, each file of a recorded object may be opened separately from one another or printed out and the user must manually sort through each file. If the user is trying to observe a changing object recorded within the files, manually printing and arranging the files often leads to error and confusion. Embodiments of the invention solve the problems associated with organizing electronic files for comparison of objects within the files by improving the process of organizing images of an event or changing object.

### SUMMARY

In one aspect, the invention comprises a computer program product for organizing files containing images for comparison of an event or object over time, the computer program product comprising a non-transitory computer readable storage medium having computer readable program code embodied therewith, the computer readable program code being configured to: establish a first image within a first electronic file as a base image including an event or object captured in the base image; establish a second image within a second electronic file as a child image including the event or object captured in the base image; establish a co-relationship between the base image to the child image, the co-relationship based on the event or object being present in both the base image and the child image; and display the base image along with the child image of the event or object in a juxtaposed format for comparison of changes to the event or object over time.

### BRIEF DESCRIPTION OF THE FIGURES

The detailed description of some embodiments of the invention is made below with reference to the accompanying figures, wherein like numerals represent corresponding parts of the figures.

FIG. 1 is a front view of on an electronic device display of a system that organizes files into a base image with co-related electronic files of subsequent images of an instance according to embodiments of the subject technology.

FIG. 2 is a front view of on an electronic device display of a system that displays a base image in juxtaposition with co-related electronic files of subsequent images of an instance according to embodiments of the subject technology.

FIG. 3 is a front view of the electronic device display of FIG. 2 with images simultaneously enlarged under a common scale.

FIG. 4 is a block diagram of a computer system/server according to embodiments of the subject technology.

FIG. 5 is a flowchart of a process of generating electronic files of images that have a co-relationship for comparison according to embodiments of the subject technology.

### DETAILED DESCRIPTION OF CERTAIN EMBODIMENTS

Broadly, embodiments of the disclosed invention provide a file sub-system for organizing images in a manner that co-relates a base image of an instance subsequently captured images of the instance. The co-relationship may be established or defined by the identity of an object or event in the instance being compared. The subsequently captured images may be displayed juxtaposed to the base image for convenient comparison of time lapsed changes to the event. In an exemplary embodiment, the file sub-system may be provided in the form of a software application that may be stored on an electronic device(s). The embodiments of the disclosed invention may be useful, for example, in evaluating patient symptoms over time.

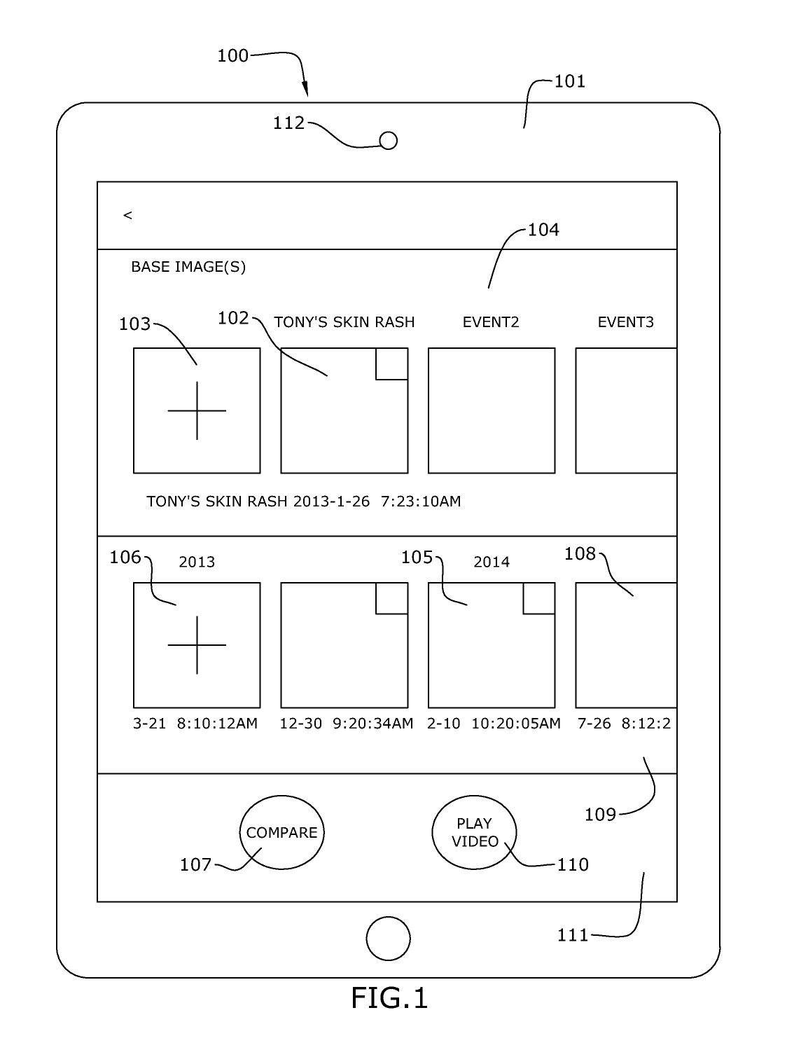

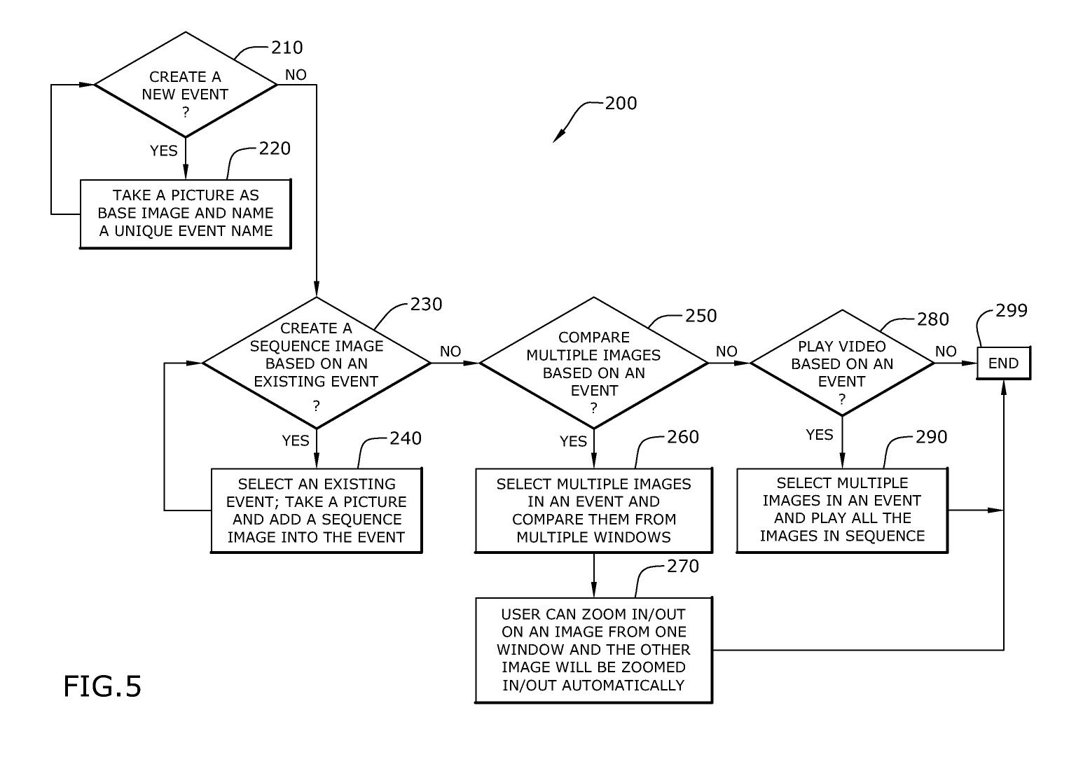

Referring now to FIGS. 1-3 and FIG. 5 a file system 100 is shown displayed in an electronic device 101 along with a process 200 of generating electronic files of images that have a co-relationship for comparison. References to block numbers in parenthesis below refer to the blocks in FIG. 5 and the actions associated with each block. The electronic device 101 may be for example a tablet computer or smart phone with a camera 112 capable of capturing images of an instance 102. An instance 102 may be for example, an object or event under observation. The system 100 may establish (210) an instance 102 as a new event stored as a first electronic file with a base image 103 of the instance 102. A user may take or select a picture as the base image 103 or parent frame via the application. The user may tag (220) the base image 103 as an instance 102 with a defined name, date and time stamp. Multiple images may be defined as base images 103 for their respective comparison to other images as shown by the process looping between blocks (210) and (220). Upon selection of the base image 103, a child frame 105 may be created (230) by taking a picture of the same object or event which is stored as an electronic file. Additional child frames 106 and 108 may be taken (240) until the user has the number of child frames desired as shown by the process looping between blocks (230) and (240). Child frames 105, 106, and 108 may be tagged with a name related to the event in base image 103, date and time stamp. The child frames 105, 106, 108 are usually taken subsequent in time to the base image 103. The child frames 105, 106, 108 may be displayed in a window pane 109 for user selection. A window pane 111 may include a button feature 107 for initiating a compare function and a play video button 110 for initiating a video function as described below.

In an embodiment of the system 100, a file folder 104 may be organized displaying the electronic file of the base image 103 in co-relation by the instance 102 to the child frame images 105, 106, 108 so that the user may compare (250) the child frame images 105, 106, 108 to the base image 103. For sake of illustration, only a selected number of the subsequently taken images (for example, images 105, 106, and 108) are called out. As shown in FIG. 1 child frame images 105, 106, 108 are displayed in time-lapsed relation to the base image 103. The user may select the child frame images 105, 106, 108 for direct comparison (260) in multiple windows to the base image 103 by pressing the compare button feature 107. The compare button feature 107 invokes a process that displays child frames 103, 105, 106, 108 for selective comparison. As will be understood, the user may select any number of child frames 105, 106, 108 and/or child frames not called out in the figures. In addition, the user may press the play video button 110 to initiate a video function (280) showing (290) selected child frame images 105, 106, 108 in time-lapsed relation to the base image 103, for example, as a video showing changes to objects or events shown in the base image 103 over time.

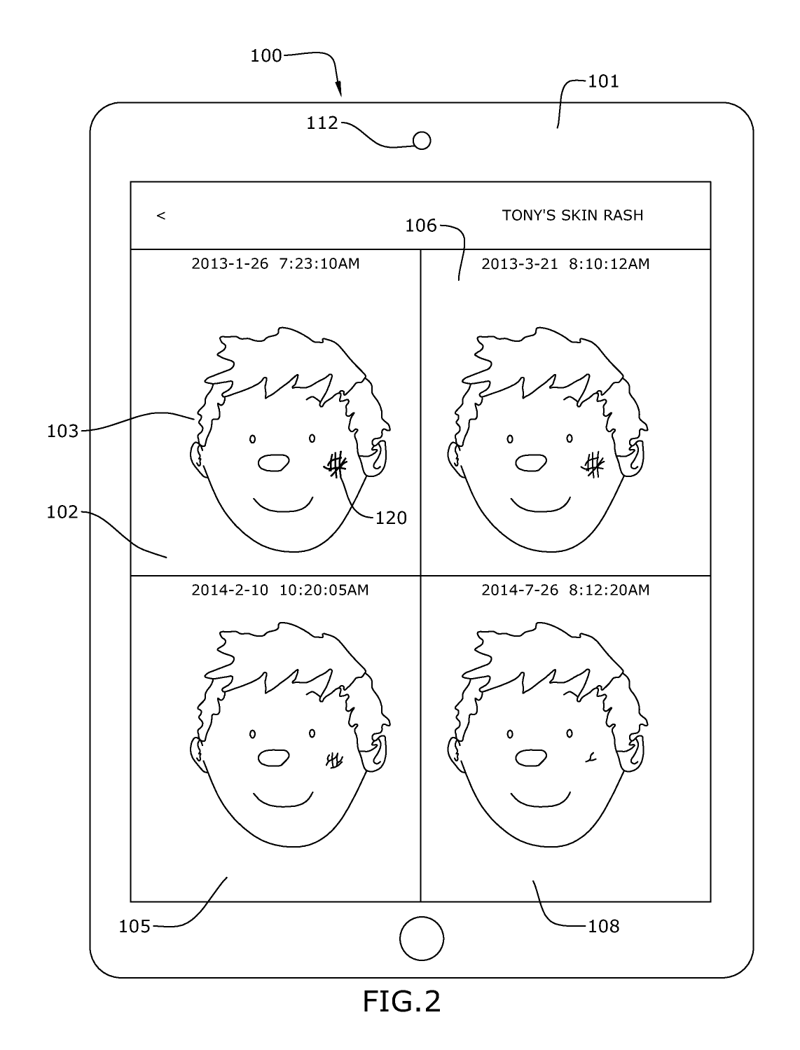

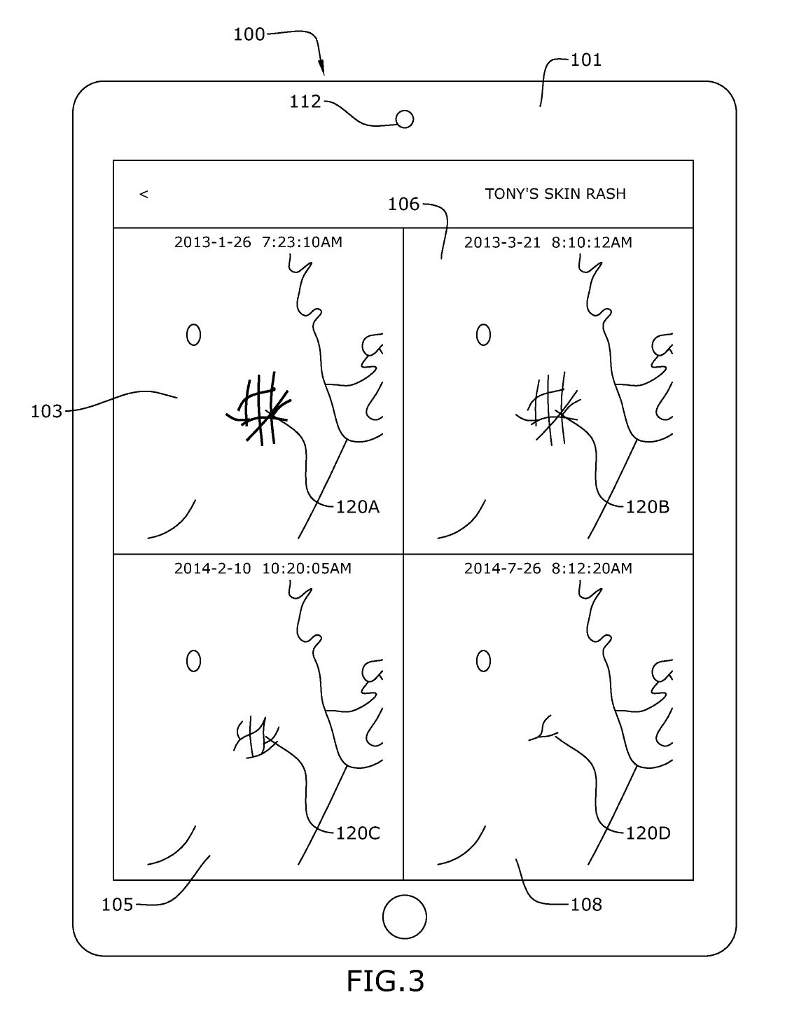

As shown in FIG. 2, the system 100 may display selected images, for example, the child frame images 105, 106, 108 in juxtaposition with the base image 103. In some embodiments, the images 103, 105, 106, and 108 may be shown at a common scale so that differences within the images may be accurately observed. While the base image 103 and the child frame images 105, 106, 108 are shown in a tiled format, it will be understood that other formats may be used that provide comparative analysis of the images 103, 105, 106, 108. The instance 102 may include an object or event 120 that may change over time. Referring to FIG. 3, the object or event 120 may be, for example, a skin rash that has developed on a patient's face. The images 103, 105, 106, 108 may be enlarged or zoomed in/out (270) simultaneously at a common scale so that changes in object or event 120 may be observed accurately. For example, if the user selects one image for enlargement, the remaining images being compared automatically enlarge at the same scale as the selected enlarged image. The user, a doctor, for example, may compare in the base image 103, the skin rash in the initial or base line state 120a to the skin rash in evolving or progressed states 120b, 120c, and 120d in child frame images 105, 106, 108. The process terminates (299) when the user ceases the comparison. As shown, the doctor may be able to evaluate changes in the skin rash 120 by comparing the various instances of the object or event 102. For example, as shown, it may be readily apparent that the skin rash 120 is changing shape, size, and intensity over time. In some embodiments, the user may enable a zoom function to enlarge the images 103, 105, 106, and 108 to better compare the progression of the object 120 over time. The electronic device 101 may include a tactile sensing display and the system 100 may include a function that zooms in (270) upon detecting two or more fingers gesturing for enlarging an area of the display.

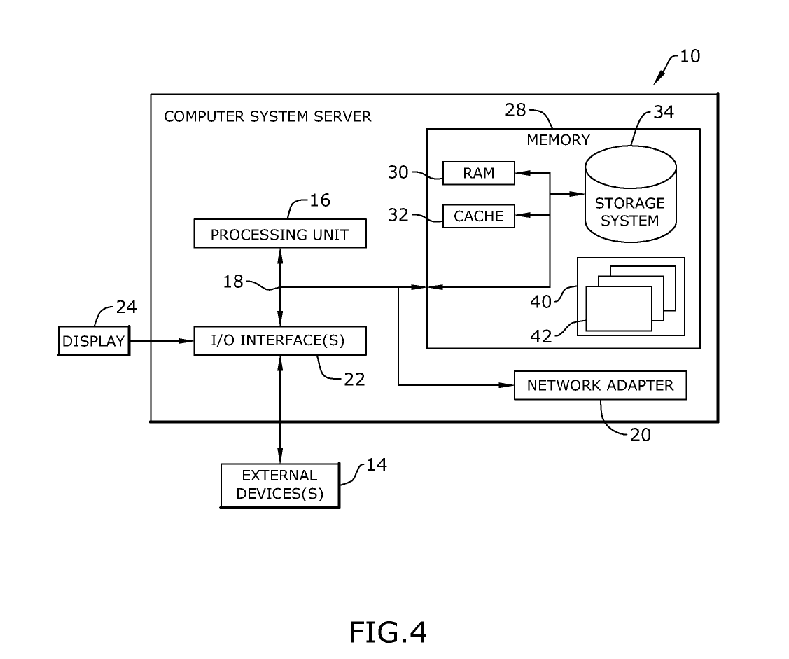

Referring now to FIG. 4, a schematic of an example of a computer system/server 10 is shown. The computer system/server 10 is shown in the form of a general-purpose computing device. The computer system/server 10 may be for example, the electronic device 101 (FIGS. 1-3). The components of the computer system/server 10 may include, but are not limited to, one or more processors or processing units 16, a system memory 28, and a bus 18 that couples various system components including the system memory 28 to the processor 16.

The computer system/server 10 may be for example, tablet devices, mobile telephone devices, personal computer systems, server computer systems, handheld or laptop devices, multiprocessor systems, microprocessor-based systems, set top boxes, programmable consumer electronics, network PCs, and distributed cloud computing environments that include any of the above systems or devices, and the like. The computer system/server 10 may be described in the general context of computer system executable instructions, such as program modules, being executed by a computer system (described for example, below). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts described herein. The program modules 42 generally carry out the functions and/or methodologies of embodiments of the invention as described above with relation to the organization of files, the display of electronic files and images in juxtaposition, and simultaneous changing of scale of images.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for organizing files containing images for comparison of an event or object over time, the computer program product comprising a non-transitory computer readable storage medium having computer readable program code embodied therewith, the computer readable program code being configured to:
establish a first image within a first electronic file as a base image including an event or object captured in the base image;
establish a second image within a second electronic file as a child image including the event or object captured in the base image;
establish a co-relationship between the base image to the child image, the co-relationship based on the event or object being present in both the base image and the child image; and
display the base image along with the child image of the event or object in a juxtaposed format for comparison of changes to the event or object over time.

2. The computer program product of claim 1, wherein the base image and the child image are displayed under a common scale.

3. The computer program product of claim 1, wherein the first electronic file and the second electronic file are tagged with a name related to the event or object and a time stamp.

4. The computer program product of claim 1, wherein the child image is an image taken subsequent to taking the base image.

5. The computer program of claim 1, further comprising computer readable code being configured to simultaneously enlarge the first image and the child image under a common scale.

6. The computer program of claim 1, further comprising computer readable code being configured to receive a button feature invoking a request to compare selectable images of the object or event and displaying selected instances of the object or event, the selected instances including the first and second images.

7. The computer program of claim 1, further comprising computer readable code being configured to provide a video function feature invoking a process showing the child frame image in time-lapsed relation to the base image to show changes to the object or event over time
